(19) United States
(12) Patent Application Publication
(10) Pub. No.: US 2020/0340409 A1
(43) Pub. Date: Oct. 29, 2020

(54) System and method for gas turbine engine control

(71) Applicant: VIETTEL GROUP, Ha Noi City (VN)

(72) Inventors: PHI MINH NGUYEN, Ha Noi City (VN); VAN SON BUI, Ha Noi City (VN); HUY HOANG NGUYEN, Ha Noi City (VN); VAN SON PHAM, Hai Phong City (VN); THANH NAM TRINH, Ha Noi city (VN)

(73) Assignee: VIETTEL GROUP, Ha Noi City (VN)

(21) Appl. No.: 16/856,344

(22) Filed: Apr. 23, 2020

(30) Foreign Application Priority Data
Apr. 24, 2019 (VN) 1-2019-02121

(51) Int. Cl. F02C 9/28

(52) U.S. Cl. CPC F02C 9/28; F05D 2260/80

(57) ABSTRACT

A system and method for controlling gas turbine engines with maximum thrust of less than 500 kgf. The control system includes electronic control unit (“ECU”), sensors and actuators. To ensure the requirement of compactness, physical control system simplicity but maintain stability and accurate operation for the engine, the control system does not include components such as Fuel Control Unit (“FCU”), alternator and corresponding rectifier circuits. A sensor, instead of alternator's wave form signal, is used to detect the rotational speed of the engine. Voltage regulation into the electric motor driving the fuel pump controls fuel flow, instead of the FCU. The control method consists of upper and lower limits computation calculation blocks of the control signal, and PID control algorithm block with coefficients designed to be suitable for the engine operating ranges. Control is implemented through a 7-step calculation process. Piecewise linearization modeling and tuning PID coefficients is also presented.

### FIELD OF THE INVENTION

This invention refers to the field of gas turbines. Specifically, it proposes a system and method to control gas turbines. The scope of this invention is aviation jet engines with a maximum of thrust less than 500 kgf.

### DESCRIPTION OF THE RELATED ART

In an aircraft gas turbine, as taught by U.S. Pat. No. 4,716,531, for example, the electronic control unit (hereinafter referred to as “ECU”) determines a command value and sends the same to a fuel control unit (hereinafter referred to as “FCU”) interposed in a Fuel Supply System that pumps fuel from a fuel tank and Supplies it to a fuel nozzle installed in a combustion chamber of the engine. An alternator is integrated in the engine and the rotational speed is detected based on the wave form generated by the alternator. A specific circuit rectifies the current from the alternator so that the microcomputer can read the output wave form. The electricity created by the alternator also serves other equipment on the aircraft.

In some gas turbines where the simplicity, compactness and affordability are the highest priorities, gas turbine with thrust under 500 kgf for small aircraft, for example, the alternator, the rectifying circuit and the FCU may become inappropriate. These components can be removed to reduce the size, volume and complexity of control system. However, without the alternator, the control system needs another method to detect the rotational speed. Without the FCU, a new solution to control the fuel flow needs to be presented.

A proportional-integral-derivative (PID) controller is a control loop feedback system that is widely used in industrial control systems. U.S. Pat. Published Appln. No. 20170023965A1 proposes a method to design an Adaptive PID Control System for Industrial Turbines, the control parameters such as Kp, Ki and Kd are calculated by the Ziegler-Nichols algorithm, the Cohen-Coon algorithm, or a combination of these and any other appropriate algorithm for tuning Kp, Ki, and/or Kd gain values. These algorithms are not based on modeling of the gas turbine, and we cannot use them to simulate the operation of the engine. Each algorithm mentioned above also has its own disadvantages. For example, the Ziegler-Nichols and related algorithms may not always work well for systems with significant dead-time, and can be too aggressive for some systems. In another example, the Cohen-Coon and similar algorithms may not always work well for systems which are modeled by integrators, such as unloaded turbines.

### SUMMARY OF THE INVENTION

The purpose of this invention is therefore to overcome the problems of the prior art by providing a system and method of controlling gas turbines. Concretely, to detect the rotational speed without the wave form generated by the alternator, an inductive proximity sensor can be used. In comparison, inductive proximity sensor is much smaller, cheaper than an alternator, but it can provide rotational speed value with equivalent accuracy. The sensor's output signal is square wave form and the instant period of the signal equals to two consecutive times the blades pass by the sensor. Based on that, the control system can calculate the engine's instant rotational speed. To control the fuel flow without the FCU, the command value generated by the ECU is used to control the speed of the electric motor which drives the gear pump.

The control method introduced by this invention is presented in the form of separate functional calculation blocks and steps to implement. Specifically, functional calculation blocks of the control method are: Procedure to verify engine status before starting; Start-up process; PID closed loop controller; Acceleration lines block; Maximum speed limit block; Compressor's safety limit block; Maximum pressure Ps3 limit block; Minimum pressure Ps3 limit block; Maximum temperature limit block; RU value limit block. Based on these blocks, the calculation steps of the control method according to this embodiment will be explained by 7 steps.

From the control perspective, a gas turbine is an object with nonlinear control characteristics. To create the model for a gas turbine with an acceptable accuracy, this invention proposes the method of piecewise linear approximation of nonlinear functions. Concretely, the total operational range (in rotational speed and Mach number) of the engine is divided into smaller ranges, and the engine's operational characteristic in these ranges is modeled by linear models. The control parameters of the PID controller are designed based on these models. These sets of control parameters are stored in the ECU and are automatically applied when the engine operates within corresponding range. The PID controller is designed and programmed so that the engine can operate smoothly even when the ECU changes set of controller parameters.

### BRIEF DESCRIPTION OF THE DRAWINGS

The above and other objects and advantages of the invention will be more apparent from the following description and drawings, in which:

FIG. 1 is an overall schematic view of a control system for a gas turbine aero-engine according to the embodiment of this invention;

FIG. 2 is a block diagram showing the configuration of control algorithm;

FIG. 3 is a block diagram concretely showing the calculation steps of the loop control algorithm, after the gas turbine has successfully started-up, therefore implementing the control method;

FIG. 4 is a 3D diagram illustrating the variation of Kp coefficient in the PID controller over rotational speed and Mach number

FIG. 5 is a 3D diagram illustrating the variation of Ki coefficient in the PID controller over rotational speed and Mach number

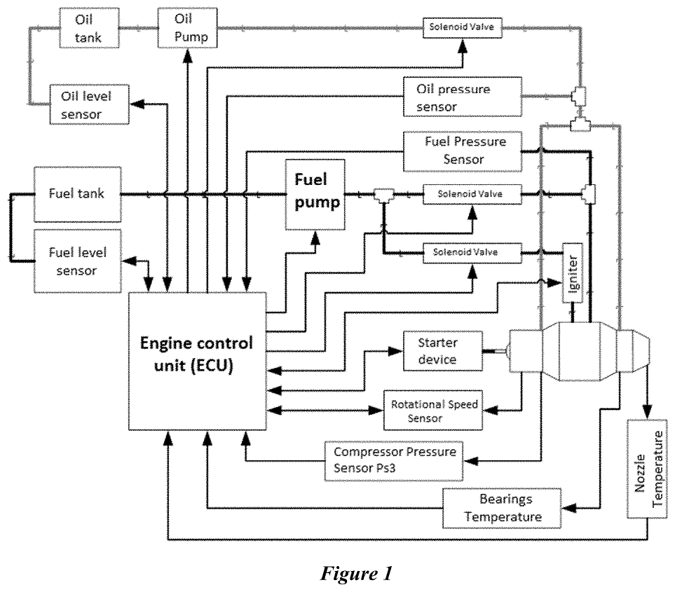

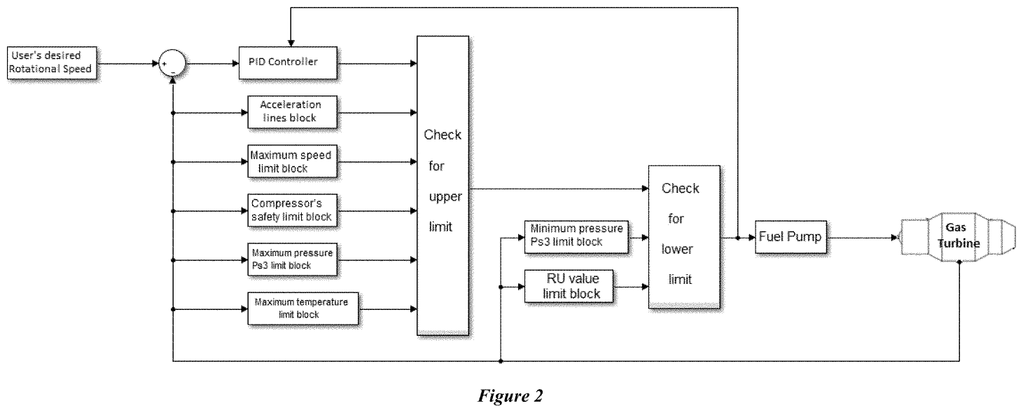

### DETAILED DESCRIPTION OF THE PREFERRED EMBODIMENTS

The System and Method for gas turbine engine control proposed by this invention will now be explained in details. The control system consists of following components:
System of sensors, including: thermocouple type temperature sensors, resistive pressure sensors, rotational speed sensor, oil level sensor and fuel level sensor. Rotational speed sensor can be of type inductive proximity or fiber-optic. Signal from the sensor is processed by an op-amp precision rectifier circuit to filter out noise. The output signal is square wave form and reflects accurately the time it takes the turbine blades to pass through the sensor, thus helping the ECU calculate the instantaneous rotational speed.
System of actuators, including: solenoid valves that open and close the fuel supply and lubricating oil line, fuel pump and oil pump driven by electric motors, ignition device, starter device (pneumatic valve to open and close compressed air, or electric starter motor, or Pyro-starter device). Fuel pump's type is fixed-displacement pump. More specifically, it is usually a gear pump. Fuel flow is adjusted by changing the electrical signal sent from ECU to the electric motor. By that way, fuel flow can be controlled without using FCU. The ignition device has a voltage amplifying device for generating sparks, which are switched on and off via a power circuit using a semiconductor device (mosfet). Solenoid valve system includes an ignition fuel valve, a main fuel valve and a lubricating oil valve; The ECU controls 3 solenoid valves in real time, by using semiconductor components (mosfet).
Engine Control Unit (ECU), contains an embedded microcomputer which is programmed with the control algorithm according to a pre-emulated control method. Electronic circuits inside ECU are designed to perform following tasks: receive and process data signals from the system of sensors; interface with computer to receive commands from user and send data about status of the engine in real-time; implement the algorithm pre-programmed in the microcomputer to generate electrical signals to control the system of actuators, therefore control the operation of engine. The microcomputer inside the ECU is microcontroller STM32F407VGT6. It is pre-programmed with the Procedure to verify engine status before starting; Start-up process; and a 7 calculation steps control algorithm containing several functional calculation blocks.

Embodiments of the invention can provide an implementation of control method that allows for controlling a gas turbine. The control method described in detail herein allows for improved performance and operational flexibility. Performance and operational flexibility may be achieved, at least in part, through the use of systems and methods that incorporate models of gas turbine operational boundaries in an online control system that may be operated in real-time. More specifically, the control method embedded in the microcomputer of the ECU can be described by functions as below:
Procedure to verify engine status before starting: checks for engine's temperatures and then generates the “ready” or “unready” status. If the status is “ready”, it allows a user to start the engine when a command “Start” is sent to the ECU by the user, and does not allow starting if the status is “unready”. This function is aimed at protection of the engine. However, if user sends the command “Force Start”, it will also allow the engine to be started.
Start-up process: the algorithm which is responsible for bringing the engine from non-working or fire off state to idle operating state. ECU performs a start-up process by controlling the actuators such as starter device, fuel pump, igniter and solenoid valves. The algorithm can be either closed-loop or open-loop. Start-up process is designed and experimented based-on aerodynamic characteristics of the engine.
PID closed loop controller: the main algorithm which is responsible for controlling the engine in real-time to operate stably according to the desired rotational speed received from user. ECU calculates PID algorithm to generate suitable electrical signal and send to the electric motor which drives the fuel pump, therefore controls the fuel flow to engine. PID controller's parameters consists of multiple sets of parameters Kp, Ki, and Kd. Each set of parameters corresponds to a range of operation (in rotational speed and in Mach number) of the engine. When the engine operates within the range, the corresponding set of parameters is applied to calculate the control signal.
Acceleration lines block: limit lines for acceleration and deceleration value while operating, defined based-on the stall margin characteristics of the engine. ECU controls the operation of gas turbine so that the acceleration line is not violated. The purpose of acceleration line is to prevent the engine from being surged.
Maximum speed limit block: Prevents the engine from exceeding the pre-defined maximum rotational speed by limiting the fuel pump control value;
Compressor's safety limit block: a limit control block during the acceleration of the engine so that the compressor does not exceed the safe threshold for operation;
Maximum pressure Ps3 limit block: Prevents the engine from exceeding the pre-defined maximum static pressure behind the compressor;
Minimum pressure Ps3 limit block: Prevents the engine from violating the pre-defined minimum static pressure behind the compressor. This block ensures that the static pressure is enough to maintain a constant fire in the combustion chamber, therefore prevents the engine from being fire-off, or shut down unexpectedly.
Maximum temperature limit block: Prevents the engine from exceeding the pre-defined maximum total output temperature at the nozzle. During operation, the engine may change its operating characteristics due to too high temperature. The aerodynamic and mechanical quality of the engine may be impaired. As a result, when the engine is forced to thrust, the temperature can rise leading to harm the engine components;
RU value limit block: RU is the ratio of fuel flow to static pressure after compressor Ps3. The function of this unit is to control the lower limit of RU value. The lower limit value ensures the deceleration process does not blow away the flame in the combustion chamber, thus] combustion process in the engine thus remains constant.

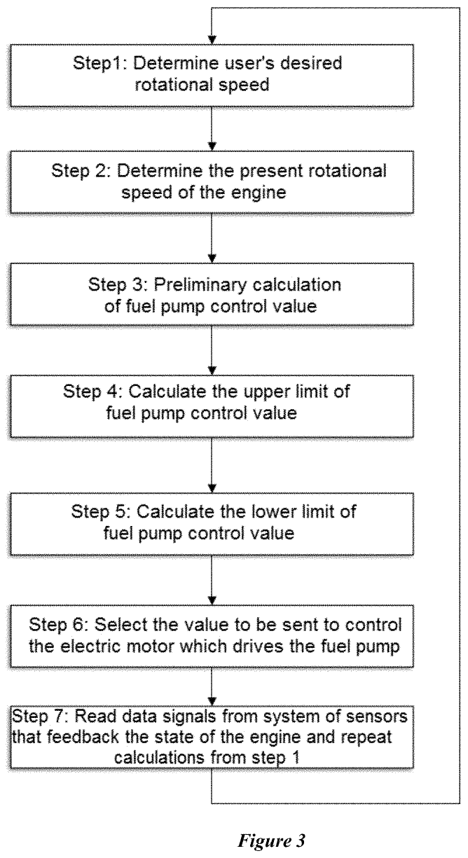

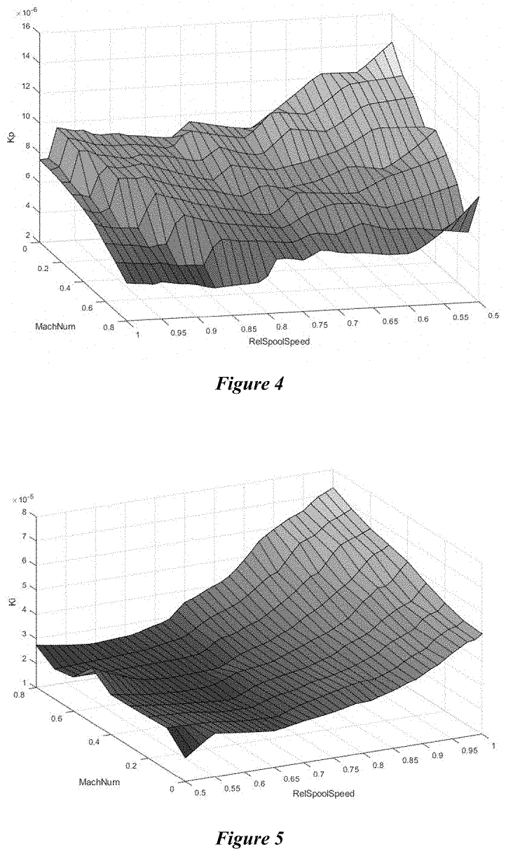

FIG. 3 is a block diagram concretely showing the calculation steps of the loop control algorithm. The control method ensures the stable operation of the engine when it has reached a self-sustaining speed. The microcomputer inside ECU calculates the control method step-by-step as follows:

Step 1: Determine user's desired rotational speed. In particular, the user sends desired rotational speed signal to microcontroller. User here can be autopilot computer of the aircraft, or a computer program in use by a human.

Step 2: Determine the present rotational speed of the engine. The actual rotation speed of the engine is detected via a sensor that can be of type inductive proximity or fiber-optic. The feedback signal from sensor is processed by an op-amp precision rectifier circuit to filter out noise. The rectifier circuit's output signal accurately reflects the time it takes the turbine blades to pass through the sensor, thus helping the ECU calculate the instantaneous rotational speed.

Step 3: Preliminary calculation of fuel pump control value by PID Controller. The value of the rotational speed specified in step 2 is combined with the value of the aircraft's flight speed (Mach number, sent from autopilot computer, if not, the default is 0) to look up the coefficients control Kp, Ki of PI controller. The ECU then calculates the PID algorithm with coefficients Kp, Ki just determined and Kd=0 to roughly calculate the fuel pump control value. Steps 4 and 5 calculate the upper and lower safety limits for the fuel pump control value. If the pump control value calculated in step 3 is within the safety limits of steps 4 and 5, it will be sent to the electric motor which drives the fuel pump, thus control the fuel flow to engine.

Step 4: Calculate the upper limit of fuel pump control value. The desired rotational speed signal in step 1 is subtracted from the actual rotation speed of the engine to find the current deviation value, then the deviation value is transmitted to five separate upper limit calculation blocks belonging to the microcomputer located in the ECU to find the upper limit of the fuel pump control value. Specifically, the upper limit calculation blocks are:
Acceleration lines block: this block helps the ECU calculate the upper limit of the fuel pump control value so that it does not violate the acceleration line, to prevent the engine from being surged.
Maximum speed limit block: this block prevents the engine from exceeding the pre-defined maximum rotational speed by limiting the fuel pump control value. This value is defined by the fuel pump control value for engine while operating at maximum rotational speed.
Safety limit block for compressors: helps ECU calculate the control value of the fuel pump during the engine's acceleration so that the compressor does not exceed the safe threshold for operation.
Maximum pressure Ps3 limit block: Prevents the engine from exceeding the pre-defined maximum static pressure behind the compressor;
Maximum temperature limit block: Prevents the engine from exceeding the pre-defined maximum total output temperature at the nozzle. During operation, the engine may change its operating characteristics due to too high temperature. The aerodynamic and mechanical quality of engine's components may be impaired. As a result, when the engine is forced to thrust, the temperature can rise leading to harm the engine components.
   The upper limit of fuel pump control value is the smallest value calculated by five above blocks.

Step 5: Calculate the lower limit of fuel pump control value. Two following calculation blocks will independently calculate the lower limits of the fuel pump control value to prevent the engine from being fire-off and ensure its stable operation:
RU value limit block: RU is the ratio of fuel flow to static pressure after compressor Ps3. This block controls the lower limit of RU value by calculating lower limit of fuel pump control value. Thus it ensures the deceleration process does not blow away the flame in the combustion chamber, therefore combustion process in the engine remains constant.
Minimum pressure Ps3 limit block: Prevents the engine from violating the pre-defined minimum static pressure behind the compressor. This block ensures that the static pressure is enough to maintain a constant fire in the combustion chamber, therefore prevents the engine from being fire-off, or shut down unexpectedly.

The maximum value calculated by two above blocks will be selected as the lower limit of the fuel pump control value.

Step 6: Select the value to be sent to control the electric motor which drives the fuel pump. If the value calculated in step 3 is within the upper and lower limits, it will be sent directly to the power amplifier circuit which controls the electric motor that drives fuel pump. If the flow value in step 3 is greater than the upper value calculated in step 4, the value sent to the pump control circuit will be the upper bound. If it is smaller than the lower limit value then the lower limit value will be used to control the fuel pump. The value sent to control the pump will be feedback to the PI controller to calculate the next integral element. By that way, the PI controller “knows” exactly the value sent to control the fuel pump. Fuel is supplied continuously to the system of atomizers inside the combustion chamber, and is burned to generate energy.

Step 7: Read data signals from system of sensors that feedback the state of the engine and repeat calculations from step 1. Rotational speed sensors, temperature sensors and pressure sensors will measure the state of the engine and feedback signals to ECU. The closed-loop control is repeated.

The present invention also provides a model-based method for tuning parameters of the PID controller. Specifically, experimental modelling, or system identification method can be used to arrive at models of physical processes. Concretely, measurements of input and output variables of the system are taken and a model is constructed by identifying a model that matches the measured data as well as possible. Since the characteristic of a gas turbine is highly nonlinear, it is impossible to find an accurate linear model to simulate the characteristics of the gas turbine. However, we can use linear model to simulate the gas turbine in a small range of operation. To simulate the overall characteristics of the gas turbine, we can combine the use of several linear transfer function models which corresponds to different small ranges of operation. This method can be called piecewise linearization.

To build the linear transfer functions that estimate the characteristics of gas turbine, experiments are conducted to collect data for building models. Operation range is separated to smaller ranges by percent of Spool speed and Mach number. Concretely, the ranges separated by spool speed percent are: Idle to 60%; 60 to 70%; 70 to 80%; 80 to 87%; and 87 to 100%. The ranges separated by Mach number are: 0 to 0.2; 0.2 to 0.4; 0.4 to 0.6; 0.6 to 0.8.

During experiments to collect data for building models, the gas turbine is controlled by an open loop algorithm. The start-up process makes the engine reach the idle state, and operator adjusts the fuel flow so that the gas turbine reaches the desired testing range. A special input signal is sent into the electric motor that drives fuel pump and thus the engine's rotational speed changes. Rotational speed is collected as the output data. Linear transfer function model is built based on input and output data. PID controller parameters are tuned based on these linear transfer function models.

What is claimed is:

1. Control system for gas turbines with thrust under 500 kgf, comprising:
a system of sensors, including: thermocouple type temperature sensors, resistive pressure sensors, a rotational speed sensor, an oil level sensor and a fuel level sensor, wherein the rotational speed sensor can be of type inductive proximity or fiber-optic;
a system of actuators, including: solenoid valves that open and close a fuel supply and a lubricating oil line, a fuel pump and an oil pump driven by an electric motor, an ignition device, a starter device (pneumatic valve to open and close compressed air, or electric starter motor, or Pyro-starter device), wherein the fuel pump's type is usually a gear pump, a fuel flow is adjusted by changing an electrical signal sent from an ECU to the electric starter motor without using an FCU,
wherein the engine Control Unit (ECU), contains an embedded microcomputer which is programmed with a control algorithm according to a pre-emulated control method, Electronic circuits inside ECU are designed to perform the following tasks: receive and process data signals from the system of sensors; interface with a computer to receive commands from an user and send data about status of an engine in real-time; implement the control algorithm pre-programmed in the microcomputer to generate electrical signals to control the system of actuators, therefore control the operation of the engine.

2. A control system according to claim 1, wherein the microcomputer inside ECU is microcontroller STM32F407VGT6 having pre-programmed functions, including: a Procedure to verify engine status before starting; a Start-up process; and a control algorithm to ensure the stable operation of the gas turbine, wherein The control algorithm consists of following functional calculation blocks:
A PID closed loop controller: a main algorithm which is responsible for controlling the engine in real-time to operate stably according to a desired rotational speed received from user;
An Acceleration lines block: limit lines for acceleration and deceleration value while operating, defined based-on a stall margin characteristics of the engine;
A Maximum speed limit block: Prevents the engine from exceeding a pre-defined maximum rotational speed by limiting a fuel pump control value;
A Compressor's safety limit block: a limit control block during acceleration of the engine so that a compressor does not exceed a safe threshold for operation;
A Maximum pressure Ps3 limit block: Prevents the engine from exceeding a pre-defined maximum static pressure behind the compressor;
A Minimum pressure Ps3 limit block: Prevents the engine from violating a pre-defined minimum static pressure behind the compressor;
A Maximum temperature limit block: Prevents the engine from exceeding a pre-defined maximum total output temperature at the nozzle; and
A RU value limit block: RU is the ratio of fuel flow to static pressure after compressor Ps3, wherein the function of this unit is to control a lower limit of RU value.

3. A control system according to claim 1, wherein the system of actuators includes:
The fuel pump and the oil pump: are of a type gear pump, and are driven by an electric motor, Their flow rate can be changed by changing a control signal sent to electric motor;
The Ignition device: has a voltage amplifying device for generating sparks, which are switched on and off via a power circuit using a semiconductor device (mosfet);
The Solenoid valves: includes an ignition fuel valve, a main fuel valve and a lubricating oil valve; The ECU controls 3 solenoid valves by using semiconductor components (mosfet).

4. Control method algorithm for gas turbine comprising 7 following steps:
Step 1: Determine the user's desired rotational speed;
Step 2: Determine the present rotational speed of an engine;
Step 3: Preliminary calculation of the fuel pump control value by a PID Controller;
Step 4: Calculate an upper limit of the fuel pump control value;
Step 5: Calculate a lower limit of the fuel pump control value
Step 6: Select a value to be sent to control the electric motor which drives the fuel pump;
Step 7: Read data signals from a system of sensors that feedback a state of the engine and repeat calculations from step 1.

5. Method for tuning PID controller parameters for a gas turbine based on experimental piecewise linearization modeling, comprising:
Measurements of input and output variables of the system are taken and a model is constructed by identifying a model that matches the measured data as well as possible, Since the characteristic of the gas turbine is highly nonlinear, it is impossible to find an accurate linear model to simulate the overall characteristics of the gas turbine, However, a linear model can be used to estimate the gas turbine's characteristics in a small range of operation, To simulate the overall characteristics, we can combine the use of several linear transfer function models which corresponds to different small ranges of operation;
To build linear transfer functions that estimates the characteristics of the gas turbine, experiments are conducted to collect data for building models; an overall operational range is separated to smaller ranges by percent of Spool speed and Mach number;
During experiments to collect data for building models, the gas turbine is controlled by an open loop algorithm, the start-up process makes the engine reach “idle” state, and an operator adjusts a fuel flow so that the gas turbine reaches a desired testing range, a special input signal is sent into an electric motor that drives a fuel pump and thus the engine's rotational speed changes, Rotational speed is collected as an output data, a Linear transfer function model is built based on input and output data, the PID controller parameters are tuned based on these linear transfer function models.
